(19) United States
(12) Patent Application Publication
(10) Pub. No.: US 2012/0222508 A1
(43) Pub. Date: Sep. 6, 2012

(54) Mechanical module for horsepower amplification

(76) Inventor: Luis Antonio Zambrana, Wilmington, DE (US)

(21) Appl. No.: 13/385,082

(22) Filed: Feb. 1, 2012

Related U.S. Application Data
(60) Provisional application No. 61/464,464, filed on Mar. 4, 2011.

(51) Int. Cl. F16H 25/12

(52) U.S. Cl. 74/56

(57) ABSTRACT

One embodiment of the horsepower amplifier module (FIG. 2) proofs the usefulness of a new approach to mechanical interventions. Mechanical advantage principles and the laws of leverage are fully exploited to increase energy efficiency while operating any horsepower producing means. Newly designed pressure ring (60), and pressure ring (61), are mounted respectably on rotary assemblies (FIG. 2B) and (FIG. 2C). Rotational energy applied to assemblies prompts the lateral displacement of components (60) and (61). A more powerful force is created and is directed to collector (78). Multiple modules supplying energy to same shaft (as shown in FIG. 3) offer a variety of options for effective operation of adopted application. A second embodiment (FIG. 4) is described as a possible arrangement available to enhance the overall capabilities of the horsepower multiplier module.

### CROSS-REFERENCE TO RELATED APPLICATIONS

This application claims the benefit of provisional patent application Ser. No. 61/464,464, filed 2011 Mar. 4 by the present inventor.

### FEDERALLY SPONSORED RESEARCH

Not Applicable

### SEQUENCE LISTING OR PROGRAM

Not Applicable

### BACKGROUND

1. Field

This invention generally relates to mechanical devices, specifically a horsepower multiplier module for energy conservation.

2. Prior Art

Present limitations inherent to horsepower producing mechanisms are causing the actual motorized equipment manufactures to adventure into fruitless new alternatives. The high cost of research and testing seldom satisfies expectations in performance and/or financial gain. Increasing the output capacity of such machines in a cost effective manner creates numerous opportunities directly and indirectly to all industries depending on horsepower technologies to sustain daily operations. My module greatly increases the reliability of any horsepower producing machine. Combustion engines burn less fuel and less battery power is required to efficiently operate electric motors.

### SUMMARY

In accordance with one embodiment, the horsepower multiplier module comprises a given array of newly discovered moveable pressure generating rings/cells. Rotating assemblies prompt a reciprocal displacement of rings to create a lateral force that is a multiple of the initially invested force. The available horsepower output of any existing or future torque generating machine or apparatus is connected to the horsepower amplifier module input gear or shaft. Immediate activation of rotating assemblies forces internally mounted composed pressure structures/rings to rotate. The rings are designed to force each other apart when rotational force is in effect. They are mounted on grooves that enable freedom of lateral movement to create an expansion process. A predetermined number of rings are installed to equalize the distance necessary to effectively apply a constant force to a rotating shaft. When two or more modules are assembled into a multi-modular configuration, the force applied to crankshaft is continuous, and rotational output is achieved. The resulting more reliable force is a multiple of the initial horsepower provider's capabilities. A high level of energy conservation is achieve when combustion chambers can operate with less fuel consumption, or chambers are totally ignored, and replaced by electric motors.

### DRAWINGS—FIGURES

FIG. 1 shows an overall front perspective view of the horsepower multiplier module of the first embodiment.

FIG. 2 is a front perspective view of the module after the top cover is removed to expose inside composition and to show how and where connections occur.

FIG. 2A is a cutaway view where some components are partially shown to disclose the mounting of carriers and the positioning of pressure rings/cells.

FIG. 2B is a front perspective view showing inside carrier assembly and the sequence of installation of pressure rings/cells.

FIG. 2C shows a partial cutaway view of outside carrier assembly in details and the installation of pressure ring/cell.

FIG. 2D is a front perspective view showing stationary frame to support CPR-B.

FIG. 2E is a cutaway view showing CPR-B restricted to lateral movement only.

FIG. 2F is a top front perspective view showing the mounting of components inherent to CPR-B and their relative location.

FIG. 2G is a top front perspective view showing the mounting of components inherent to CPR-A and their relative location.

FIG. 2H is a cutaway view showing smooth transition point for rollers.

FIG. 3 is a general view of a modular set up applying continuous force to shaft.

FIG. 3A is a top back view of planetary gear arrangement.

FIG. 4 is a cutaway view of a second embodiment showing chain location.

FIG. 5 perspective view of a combination of power generating devices.

### REFERENCE NUMERALS

| | |
|---|---|
| 10 | input shaft |
| 12 | gear |
| 14 | gear/wheel |
| 16 | support shaft |
| 17 | pin |
| 18 | gear |
| 19 | bolt |
| 20 | gear |
| 22 | gear |
| 24 | chain |
| 26 | gear |
| 28 | bolt/shaft |
| 30 | chain |
| 32 | carrier gear |
| 32B | carrier gear |
| 32C | carrier gear |
| 34 | frame/flange |
| 38 | cylinder/frame |
| 39 | stationary frame |
| 40 | groove/channel |
| 42 | inside carrier gear |
| 42B | inside carrier gear |
| 42C | inside carrier gear |
| 44 | strut |
| 45 | opening/cuts |
| 46 | groove/channel |
| 47 | stabilizer |
| 48 | mounting shaft |
| 50 | lobes/cams |
| 52 | mounting flange |
| 54 | bearing |
| 58 | pressure adjust |
| 60 | composed ring A |
| 61 | composed ring B |
| 62 | base |
| 63 | base |
| 66 | mounting arms |
| 68 | bearings |
| 70 | roller mount |
| 72 | roller |
| 73 | merging point |
| 78 | force collector |
| 78B | collector cylinder |
| 80 | pivot rod |
| 82 | end rod |
| 82A | end rod |
| 82B | end rod |
| 82C | end rod |
| 84 | crankshaft |
| 85 | one way bearing |
| 86 | crank arm |
| 88 | accessory gear |
| 90 | coupler |
| 92A | frame/casing |
| 92B | bottom halve casing |
| 92C | top halve casing |
| 94 | bolts |
| 96 | center gear |
| 98 | contact gears |
| 100 | ring gear |
| 102 | ring gear shaft |
| 104 | transfer gear |
| 106 | transfer gear |
| 108 | idler gear |
| 110 | idler gear |
| 111 | housing |
| 116 | casing |
| 118 | chain |
| 120 | gear/guide |
| 122 | modified collector |
| 124 | chain terminal |
| 126 | adjusting bolt |
| 130 | first stage module |
| 132 | electric motor |
| 134 | battery pack |
| 135 | output gear |
| 136 | generator pulley/gear |
| 137 | electric generator |
| 138 | second electric motor |
| 139 | generator pulley/gear |
| 140 | second stage power multiplier module |
| 142 | coupling device |
| 144 | torque converter |
| 146 | transmission |
| 148 | chain/belt |
| 150 | female threading |

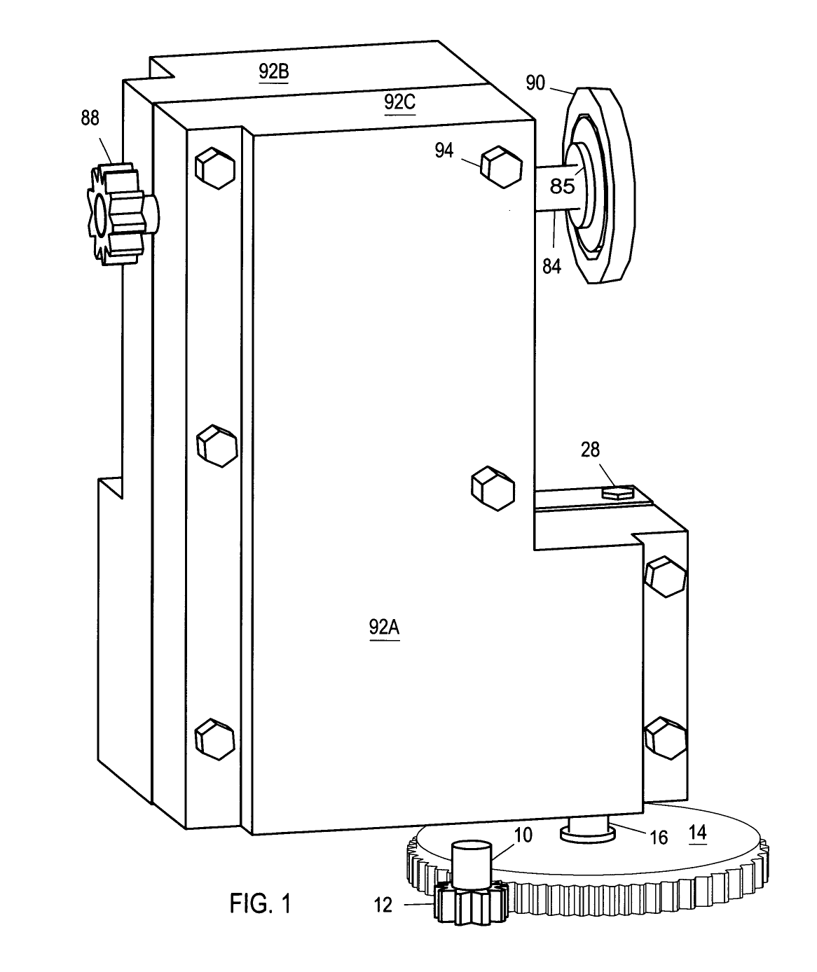

### Detailed Description —FIGS. 1, 2, 2A-2H, 3, and 3A—First Embodiment

FIG. 1 (front perspective view) shows an overall view of the horsepower amplifier of the first embodiment. The horsepower amplifier is a mechanical device designed to multiply the magnitude of any rotational force applied to input gear/wheel 14. Rotating assemblies and a preselected number of gears mounted on frame/housing 92A are connected to gear 14 to create a more powerful directional force upon activation. The magnitude of the original input force (TORQUE) and the rate of rotation (RPM) are significantly increased. The reliability of current electric or fuel driven horsepower sources is potentially increased to satisfy current needs.

Frame 92A is a two halves housing. Bolts 94 are torqued to threading 150 to support halves 92B and 92C after a gasket or seal (not shown) is installed on mating surfaces to prevent oil or fluids leakage. Bearings (not shown) are installed where inner components depend on housing 92A for support and operation. Frame 92A provides for the mounting of carrier assemblies and a given arrangement of gears.

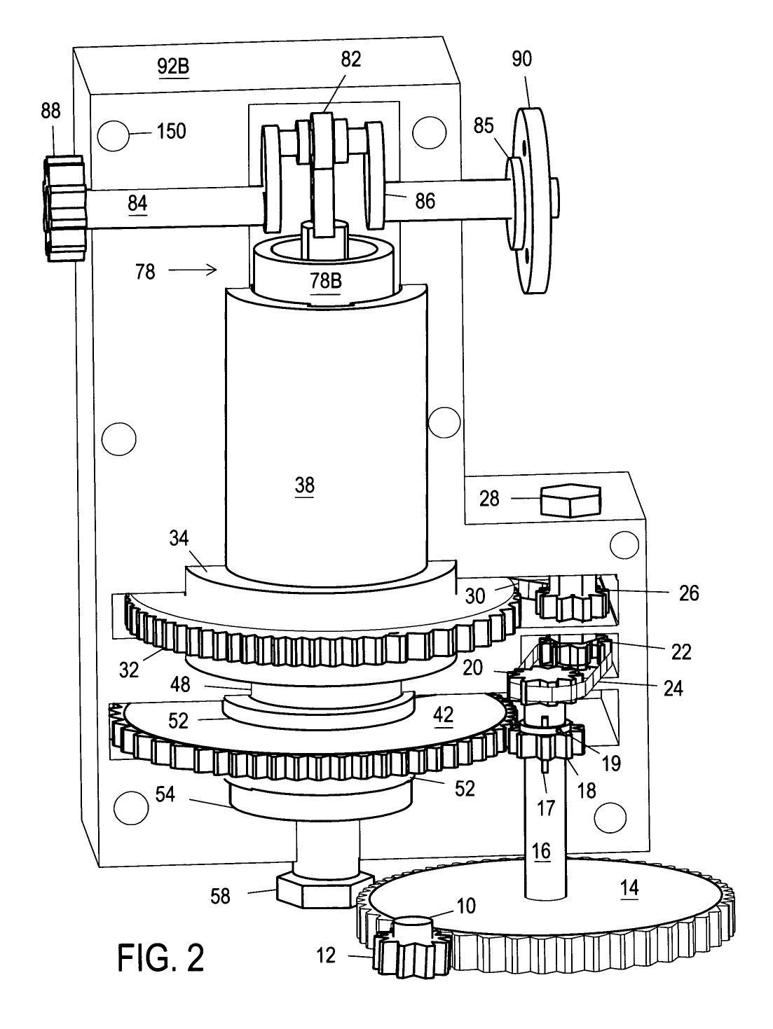

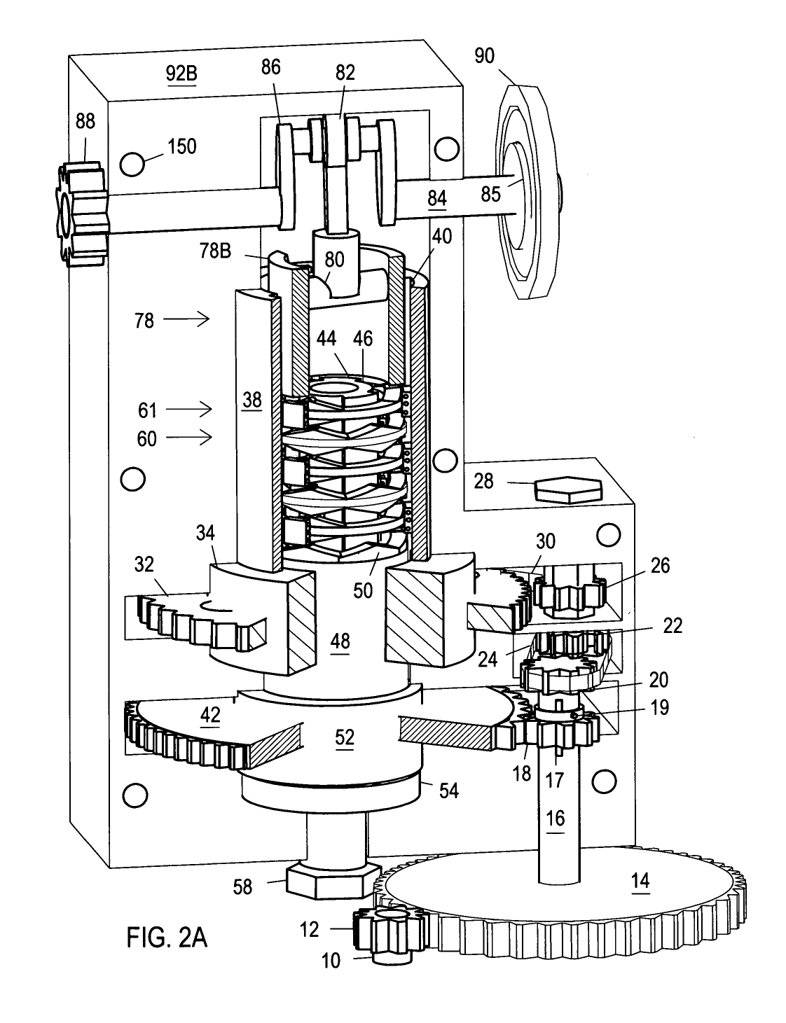

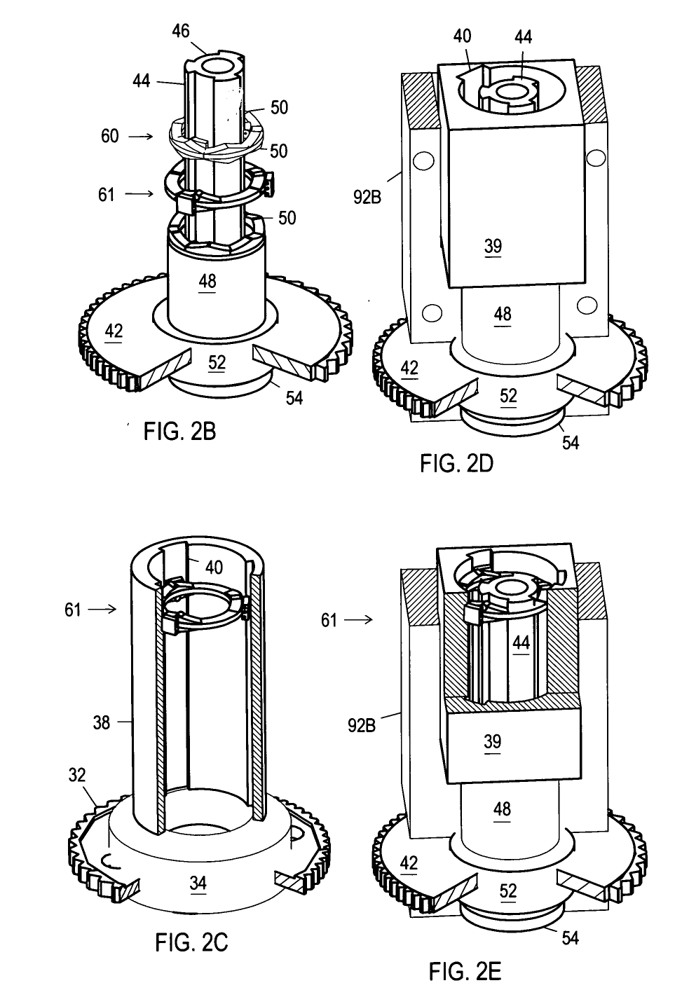

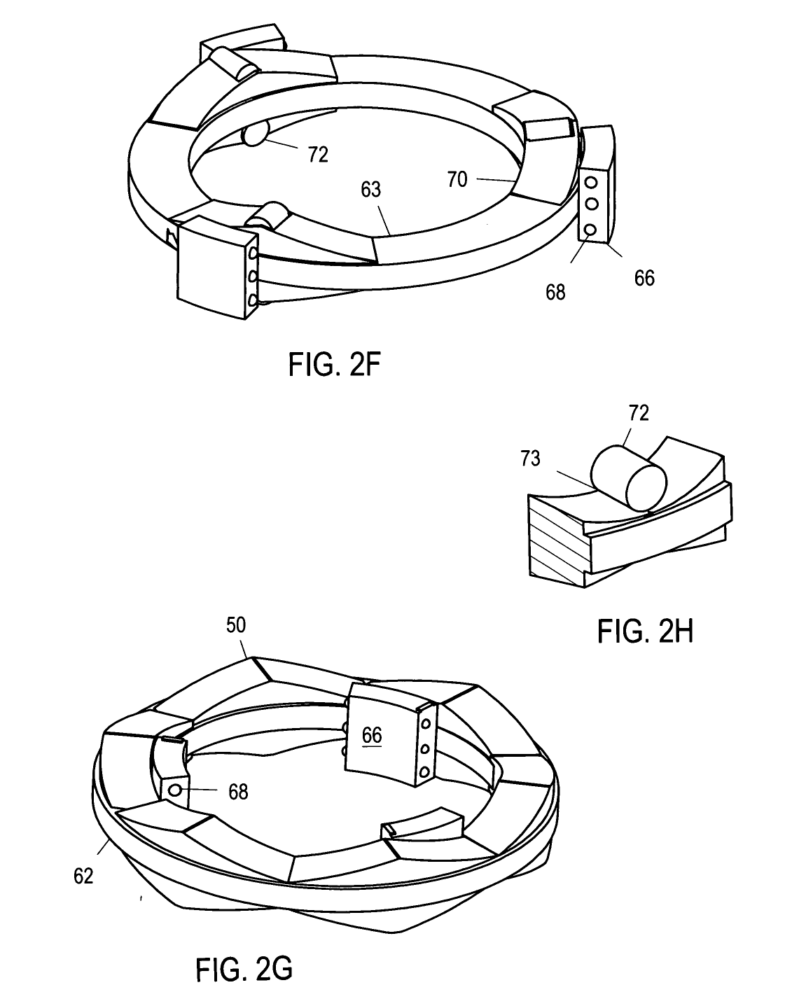

Inside carrier assembly, best shown in FIG. 2B (front perspective view), comprises gear 42, flange 52, mounting shaft 48, rank of cams 50, and strut 44. Outside carrier assembly, best shown in FIG. 2C (front perspective view), comprises gear 32, frame/flange 34, and cylinder 38. Cover 92C is removed in FIG. 2, and FIG. 2A (front perspective views) to provide the reader a more comprehensive view of the inside composition of the horse power multiplier of the first embodiment and to show how and where connections occur. Main gear 14 is attached to shaft 16 for support and follows gear 12. Gear 14, gear 18, and gear 20, are secured to shaft 16 and follow the same direction of rotation. Rotational energy is transferred to gear 42.

Collector 78, best shown in FIG. 2A (top front cutaway view), comprising; cylinder 78B, pivot rod 80, and rod 82, applies generated directional force to shaft arms 86 attached to shaft 84. The directional force is converted to rotational energy and distributed to application of choice.

Gear 18 is secured to shaft 16 by pin 17 or similar device and it is secured by bolt 19. Gear 42 is connected directly to gear 18 to rotate in opposite direction. Gear 20 mounted on same shaft 16 will rotate in the same direction of gears 14 and 18. Chain or belt 24 connects gear 20 to gear 22 securing same direction of rotation. Gear 26 and gear 22 are mounted on same shaft and rotate in same direction as gears 14, 18, and 20. Bolt 28 is inserted through a first opening in casing 92B and is threaded to female threading on second opening after gear 26 and gear 22 are in place. A portion of bolt 28 after the head and before the threading exhibits square corners or means to secure the stability of both gears are installed.

A chain or belt 30 connects gear 26 to gear 32 to maintain the same direction of rotation as gears 14, 18, 20, 22, and 26; that is the opposite direction of gear 42. The function of all installed gears is to transfer available input power to inside carrier (FIG. 2B) and outside carrier (FIG. 2C) and to guarantee opposite direction of rotation to gears 32 and 42. Connecting gears 18, 20, 22 and 26 are the same size to guarantee an equal amount of force is applied to gears 32 and 42. Gears support shafts 16 and 28 are mounted on respective frame half 92B or 92C following the gears positioning within the horsepower multiplier module's components arrangement. Strut 44 is permanently attached to shaft 48 and is modified with longitudinal grooves or channels 46, cut in the outer surface to hold and support compose pressure ring-A 60 (refer to as CPR-A, hereafter and fully shown in FIG. 2G) comprising; cams 50, base 62, mounting arms/brackets 66, and bearings 68. The center of strut 44 is hollow to minimize its total weight, to add strength and material conservation. Shaft 48 permanently secures the position of gear 42 directly or by a flange 52 when provided. Shaft 48 is also the mounting shaft for the whole inside carrier assembly. A rank of cams/lobes 50 is mounted circumvent to strut 44 on same end where strut 44 joins shaft 48.

The rank of cams 50 comprises a series of protrusions joined together to guarantee the smoothest possible transition to rollers 72 travelling from cam to cam at high speed and under pressure. The joining/transition points 73 (FIG. 2H) are to follow the curved surface contour of rollers 72. The minimum curved distance is calculated at point 73 to avoid distortion of the straight path rollers are required to follow from bottom to crest of cams. Some clearance is left between strut 44 and cams 50 and also some clearance is left between cams and outer edge of shaft 48 to avoid interference with other components. The angular distance between cams from any reference point, be the base or the crest, is equal on any given array chosen and installed. Crafting or manufacturing a rank of cams/lobes 50 all in one piece as a unit will add to overall accuracy and better performance. Gear 42 is permanently secured to shaft 48 and brings rotational force to set of cams and whole inside carrier assembly (FIG. 2B).

Outside carrier support flange 34 is pivotally mounted on shaft 48 and positioned on mounting half 92B as shown in FIGS. 2 and 2A for full stabilization after casing half 92C is bolted to bottom half 92B. Some embodiments of the horsepower multiplier module require no bearings and in some instances a cylindrical shape liner is installed where contact occurs for friction control.

Inside carrier assembly is placed in pre-cut opening in frame/flange 34 before the actual positioning on casing 92A occurs. A thrust bearing 54 is placed between flange 52 and casing 92A. A pressure control device (not shown) could be mounted before bearing 54 is installed when a substantial amount of horsepower is anticipated. When rotational force is applied to gear 42 (fully shown in FIG. 2) the whole inside carrier assembly (FIG. 2B) will rotate. Rings 60 mounted on grooves 46 are forced to follow same direction of rotation as gear 42. Flange 52 extends to both sides of gear 42 and provides the mount for inside carrier to casing 92A.

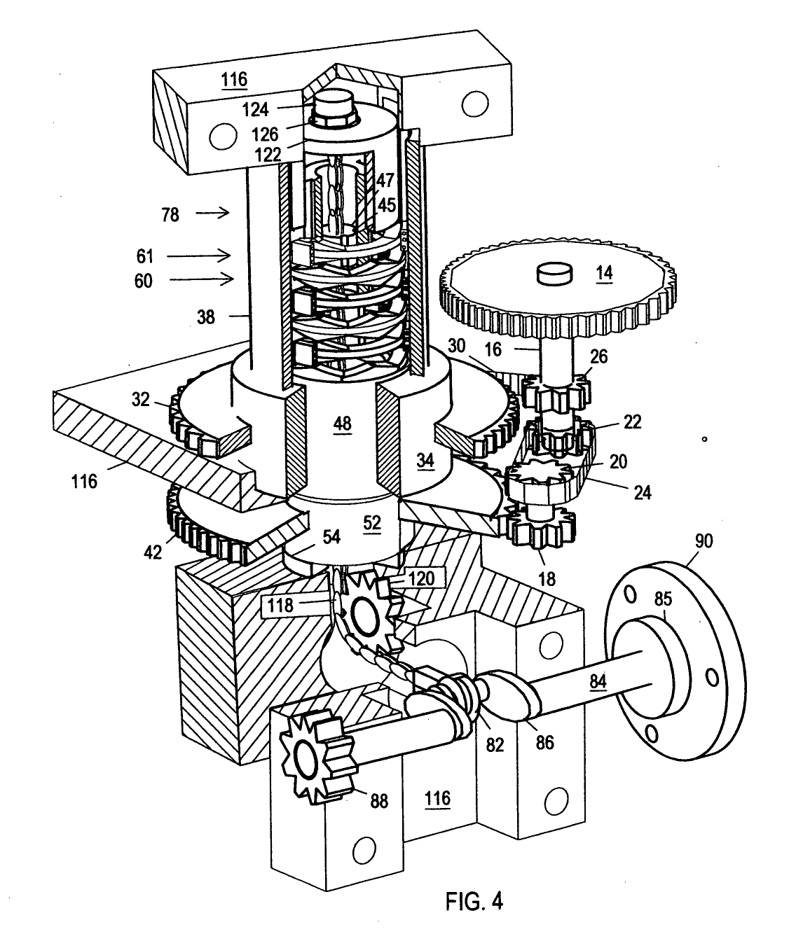

Set of cams 50 mounted on base 62 is identical to the set secured to shaft 48 and are permanently attached on both sides of base 62. Support arms 66 are attached inside the perimeter of base 62 equidistant to each other and will provide support necessary when CPR-A is mounted on inside carrier as shown in FIGS. 2A, 2B, and 4. When CPR-A is manufactured all in one piece as a unit; A two piece mold is made following the shape of arms 66, the shape of support base 62 and the overall surface contour of any given rank of lobes. Bearings 68 also shown in FIG. 2F and 2G are installed on both sides of arms 66 where contact is made with strut 44 to minimize the effects of friction. Roller bearings or means for friction control are required for more complex applications when the demand for horsepower is greater.

Outside carrier assembly, best shown in FIG. 2C, is mounted on casing 92B as, shown in FIGS. 2 and 2A. Cylinder 38 is equipped with grooves or channels 40 designed to hold in place compose pressure ring-B 61 (refer as CPR-B hereafter and best shown in FIG. 2F)) comprising; base 63, roller mount 70, roller 72, arms 66 and bearings 68. Freedom of rotational and reciprocal directional displacement is maintained when ring 61 is installed. The cylindrical enclosure is permanently attached to frame 34 for support and rotational movement following the activation of gear 32 (fully shown in FIG. 2) also mounted on same frame 34. Shaft 48 and frame 34 are pivotally mounted to rotate in opposite direction at high speed and under constant pressure.

Outside carrier can be replaced by a suitable stationary frame 39 shown in FIG. 2D (front perspective view) and FIG. 2E (cutaway view) restricting CPR-B to directional movement only. CPR-A maintains reciprocating displacement and rotational movement capabilities. Either assembly can be held stationary while second assembly rotates. Two active assemblies increase output speed at shaft 84.

CPR-B 61, best shown in FIG. 2F, brackets/arms 66 are similar to the set installed to secure CPR-A, but are installed on outer perimeter of support 63. Rollers 72 are precisely mounted to coincide with the position of the cams on CPR-A. Rollers maintain contact with surface contour offer by the rank of lobes at all times while rotating and oscillating. Only the minimum calculated gap for lubricants is permissible between rollers and cams. Same condition for contact applies to rollers 72 and bearings 68 when mounted on respective grooves 40 or 46 provided by carriers.

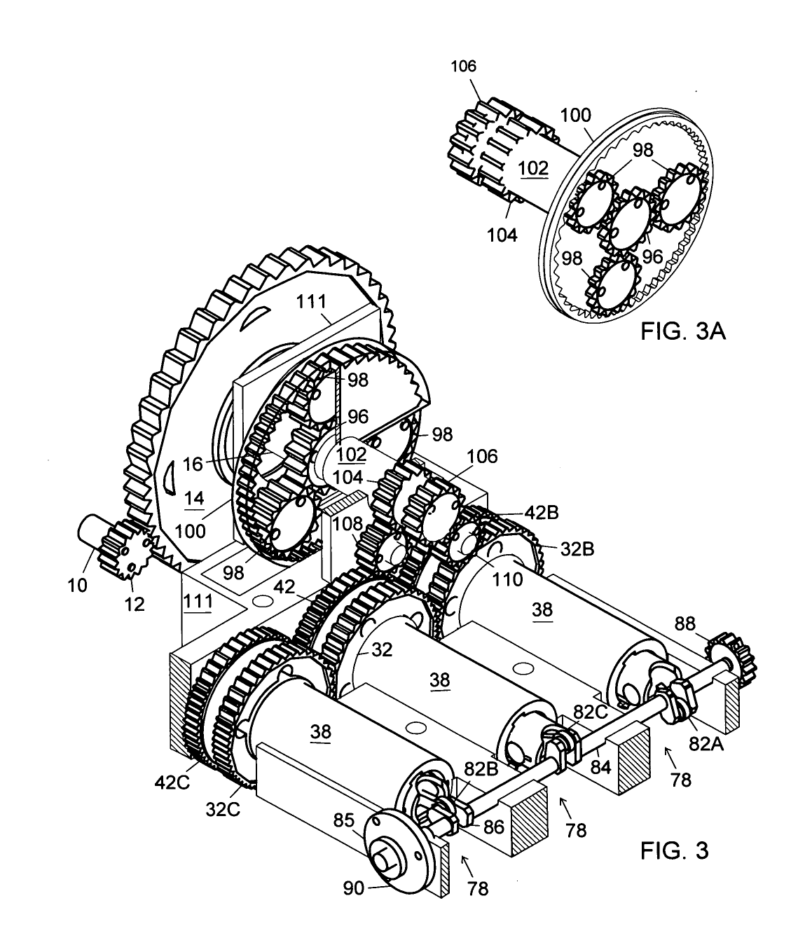

A suitable force collector 78 best shown in FIG. 2A, is installed and maintains continuous contact with last ring as it follows the reciprocating directional movement caused by the interaction of the rotating array of rings. Cylinder 78B is built to slide inside cylindrical support 38 and also slides on strut 44 as shown in FIG. 2A. Both components will maintain said collector in place while reciprocating directional displacement is in effect. End rod 82 is attached to pivoting rod 80 mounted inside cylinder 78B on the opposite end where cylinder 78B meets the CPRs. The function of rod 82 is to transfer the force generated by the CPRs to crank arm 86 and shaft 84 as shown in FIGS. 2, 2A, and 3. One way bearing 85 is installed on end of shaft connected to output coupler to eliminate the effects of back pressure.

All components of the horse power multiplier described above are built with the hardest, lightest and most durable material available and currently used for the manufacturing of any possible application. The same reliable material currently in use for the manufacturing of fuel propelled vehicles is required when a module is manufactured for transportation or any other purpose.

When power generators, motorcycles or any other mid-range horsepower demand exists, the material currently in use to manufacture the components of the motor powering those devices or machinery will be used to build the horsepower multiplier module. Variations in material are acceptable but not limited to toy manufacturing, lawn mowers, go carts and any other low horsepower operating machine or apparatus. FIG. 3 and FIG. 3A (top perspective views) show a possible configuration where end rods, 82A, 82B, and 82C supply the output horsepower generated by three independent modules to shaft 84. Gear 14 is attached to shaft 16. Gear 96 positioned at the center of gears 98 initiates the power transfer and forces all three gears 98 to rotate. Set of gears 98 connect the rotational force to ring gear 100 (fully shown in FIG. 3A), partially modified to expose gears 98, gear 96, and shaft 16 and its center shaft 102. Gears 104 and 106 are also attached to shaft 102. Gear 108 placed between gear 42 and gear 104 connects power to gear 42 without changing direction of rotation.

Gear 42 is in direct contact with gear 42C to change direction of rotation and power transfer. Gear 42 is also in direct connection with gear 42B for power transfer and change of direction of rotation. Gear 110 placed between gears 32B and gear 106 provides power to gear 32B while maintaining the same direction of rotation. Gear 32B is directly connected to gear 32 for power transfer and to change direction of rotation. Connecting gear 32 to gear 32C will rotate gear 32C the same direction as Gear 32B. A suitable housing 111 (partially shown) secures all components in place. The output power generated is applied to shaft 84. One end of shaft 84 holds gear 88 or a pulley (not shown) if needed to run accessories. The other end of shaft 84 is connected to a suitable power coupler 90 with the capacity to efficiently transfer power to intended application.

### Operation—First Embodiment—FIGS 2A-2H, FIGS. 3, 4, and 5

FIG. 2A (top perspective view) shows a significant size wheel 14 connected to a smaller gear 12. Output shaft 10 provides rotational energy from a horsepower producer (not shown) to gear 12. Wheel 14 will turn slower than gear 12 but the total force or torque applied to shaft 16 is greater. That greater force is applied to gear 18 and gear 20 mounted on shaft 16. Gear 42 is in direct connection with gear 18 and will activate inside carrier and its components. The rank of cams/lobes 50 and the CPRs-A mounted on strut 44 will rotate in same direction as gear 42. A third gear 20 secured to shaft 16 transfers the incoming force to gear 22.

A chain or belt 24 is installed to maintain same direction of rotation. Gear 22 and 26 are mounted on same shaft 28 to rotate as a unit following the same direction of gear 20. A second chain 30 is installed to connect gear 32 to gear 26 maintaining same direction of rotation and torque is applied to outside carrier. Gears 18, 20, 22 and 26 are arranged and connected to guarantee opposite direction of rotation for inside carrier (FIG. 2B) and outside carrier (FIG. 2C). CPR-B (FIG. 2F) mounted inside cylinder 38 as shown in FIGS. 2A and 2C will follow rotational movement of gear 32. The rotational movement prompts CPRs to follow the circular array of cams 50, mounted on, or built in as part of shaft 48. The first array of cams or lobes that CPR-B encounters is set 50 protruding from shaft 48. The cams are permanently restricted to shaft 48 holding it. That condition forces CPRS to create a lateral push, apart from shaft 48 as they travel on the circular pattern following the sloppy contour created by cams positioned on their path.

Following the effects of leverage, the magnitude of the lateral force felt at a single cam and applied to rollers 72 is also available on opposite acting cam comprising a given rank. The cams on all CPRS A (FIG. 2G) produce the same effect inducing contiguous rings CPR-B (FIG. 2F) to start the expansion process.

CPR-B 61 is installed on cylinder/frame 38 as shown in FIG. 2A to be followed by a CPR-A 60 as shown in FIG. 2B. A calculated number sequence of rings is inserted on grooves 46 and 40 to obtain expected results. The mounting grooves holding rings in place make possible an oscillating displacement as rings rotate and interact with the sequence of cams. CPR-B is positioned first, next to cams 50; then, CPR-A follows, alternating from CPR-B and CPR-A to complete a full array. The last ring mounted is CPR-B to eliminate friction effects when pressure is exerted against cylinder 78B. Applied turning force prompts rings to race to the crest of the cam and away from shaft 48 and then return to bottom position at other end of cam. That move is equivalent to one full rotation of arms 86 and shaft 84.

The distance measured from base of cams to crest is equal to the directional distance the ring is forced to expand. The alignment of all cams at the top equalizes the distance that collector 78 will travel. Rollers 72 inserted on mount 70 maintain constant contact with cams surface to ensure smooth operation of every individual ring comprising the module. Activating input gears 32 and 42 forces the respective assemblies to rotate, urging the rings/cells to interact with each other, creating a multiple of the initial force. The minimum gap required for rollers to efficiently operate on cams surface is achieved when adjusting mechanism/bolt 58. The bolt is properly installed to control the positioning of thrust bearing 54 at end of shaft 48.

Bearings or means for friction control is installed at bottom of cylinder 78B if rollers are not mounted where CPR-B contacts cylinder. The embodiment shown in FIG. 2A is equipped with only five CPRs for simplicity. A higher number of rings is required when a substantial amount of horsepower is anticipated. Every single set of lobes 50 adds to the full expansion of the array mounted on inside carrier (FIG. 2B) and outside carrier (FIG. 2C) as rollers are forced to reach cams' crest.

A second and third module also in operation as shown in FIG. 3 return CPRs to original position at bottom of cams. The lateral force applied to cams is more powerful when collected close to the center of shaft 48. When considering the number of lobes or cams to be mounted or crafted as part of base 48, one is cognizant that a smaller number of cams/lobes indicates more efficiency. Gear 14 is made as large as possible to exploit the mechanical advantage principles. The revolutions per minute (rpm) are regained by the interactive activities of cams in operation. Also the gear ratios activating carriers and the number of cams installed on the array 50 determine the (rpm) multiplier. The gear ratios and the number of rings mounted on inside carrier and outside carrier will determine the total force applied to arm 82 and shaft 84. The number of rings mounted on carriers and the height of the lobes will dictate the length of arm 86. The more rings, and the higher the slope they climb, the more force (torque) applied to shaft 84.

Some configurations of the horsepower multiplier including, but not limited to, stationary embodiment shown in FIGS. 2D, and 2E can be designed into one stage to produce more rpm while a second stage increases the total torque. The opposite also holds true. FIG. 3 (top front perspective view) shows three modules connected to same shaft 84 to maintain a constant rotational force throughout a full revolution period. The full force is applied to arms 86 by the module operating at the most effective angle, as shown by the actual position of rod 82A, in reference to the given angular position of shaft 84. The next module output rod 82B will simply follow the rotation of shaft 84 to reach the point of most effectiveness and the third module rod 82C completes the rotational cycle and continues to the next. The usefulness and reliability of the horsepower multiplier can be enhanced by installing two or more modular arrangements similar to FIG. 3 and/or FIG. 4 where the output of a first unit is applied to a second unit.

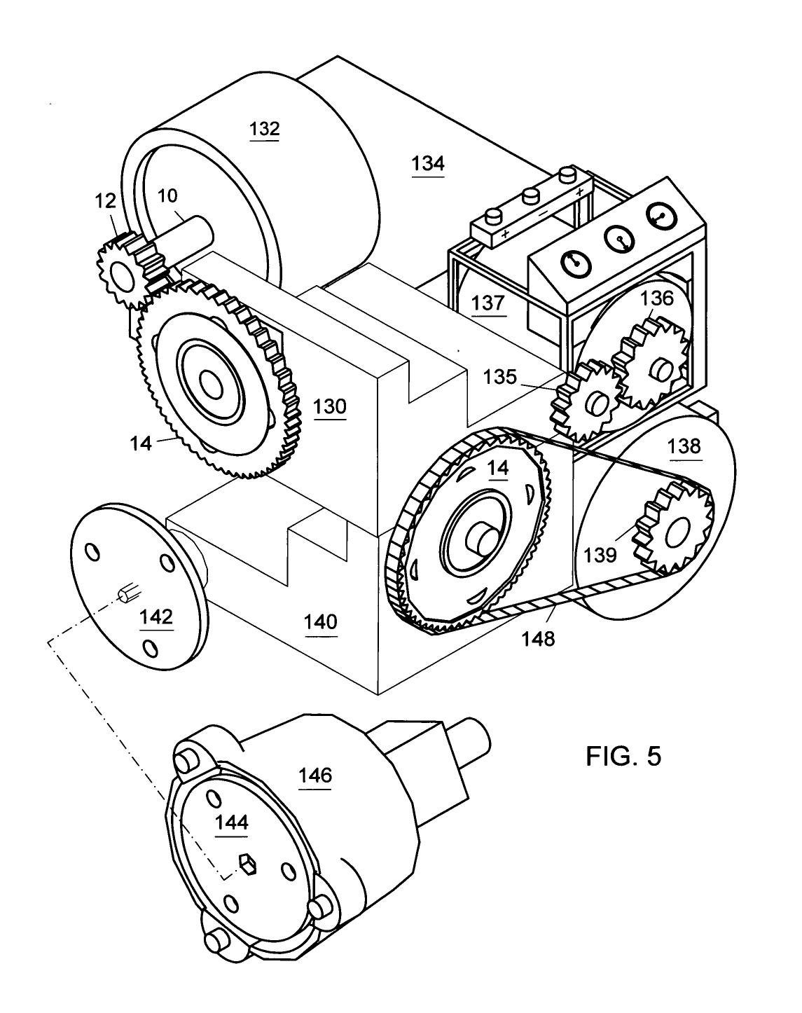

FIG. 5 (top front perspective view) is a general view of a practical modular arrangement activated by any power generating means. The current technologies 132 (electric motor) and 134 (battery pack with recharging capabilities) is applied to a first stage 130 of a two stage module arrangement. A second stage 140 amplifies the results from first stage and applies a more powerful force to input torque converter 144 for full operation of transmission 146 or similar device.

Another possible arrangement combines a DC electric motor 132—made by D&D motor systems which are rated at 10.1 peak horsepower @5080 rpms for 48 volt applications—with the horse power amplifier module 130 shown in FIG. 3 or module shown in FIG. 4. The output at gear 135 is applied to gear 136 to run an on-board small electric generator 137 to provide the voltage necessary to run a more powerful motor 138. A chain or belt 148 couples power from second electric motor 138 to input power gear 14 of second module of choice 140. The resulting horsepower product is then applied to suitable coupling device 142 connected to the drive train of any application that depends on a substantial amount of horsepower for operation.

In another configuration (not shown), the output horsepower produced by a DC electric motor—supplied by D&D motor systems (golfcartcatalog.com)—which is rated at 10.1 peak horsepower (hp) at 5080 rpms and produces a ground speed of up to 22 mph, is applied directly to a first stage of a two stage horsepower multiplier module. The first module converts the hp to about 40 or better for a ground speed nearing 50 mph mark. That output is applied to a second module bringing it up to a higher level capable of propelling a vehicle of choice on public roads. A kohler fuel twin cylinder 4-cycle 20 horsepower engine currently available at (brandnewengines.com) can achieve similar or better results. Any rotational energy source can be adapted to any embodiments of the horsepower multiplier. The final results can be anticipated as required by the relevant application.

### Description and Operation—Second Embodiment—FIG 4

FIG. 4 is a front perspective view of a second embodiment of the horsepower multiplier module. A portion of cylindrical support 38 and frame 34 are removed to fully disclose CPRs mounted on respective assemblies and to show chain 118 routing. A single horsepower multiplier module is mounted to casing 116 (partially shown in three pieces) to provide a better view and understanding the full operation of the second embodiment. Two or more modules are connected to ensure continous force is acting on shaft 84 to pull chain 118 and all CPRs back.

Mounting frame or casing 116 is modified to allow the mounting of sprocket gear 120 if necessary to follow the location of arms 86. Shaft 84 is mounted on a different location in relation to first embodiment and can be mounted at any angle to provide more flexibility when output coupling device 90 or gear 88 are connected to application. Shaft 16 replaces bolt 28 as shown in FIG. 4. All components necessary to operate inside carrier (FIG. 2B) and outside carrier (FIG. 2C) are the same as the first embodiment and are installed the same manner and same location. The end of the casing where chain 118 holding terminal 124 is located is large enough to permit the flow of lubricating means and provide accessibility to adjusting bolt 126.

A modified power collector 122 is installed in same position as first embodiment as shown in FIG. 2A, and FIG. 4. Collector 122 is a combination rod and cylinder with an opening on end that slides on inside carrier. The other end is made thick and sturdy enough to hold chain 118, a rod or a cable (not shown) while applying the pulling force to arms 86. Chain 118 is routed through center of all components of the horsepower multiplier module to connect with shaft 84. A suitable size rod bearing or stabilizer 47 secured to chain 118 prohibits chain contact with inside wall of shaft 44 while following reciprocating movement under stress. Longitudinal cuts 45 outside surface of rod 47 minimize its weigh and permits the flow of lubricants.

The chain can be permanently secured to holding terminal 124 and end rod 82 (as shown in FIG. 4) considering the angle presented to end rod 82 after the positioning of shaft 84 is determined. Terminal 124 is torqued to female theads in center hole removed from bolt 126. Bolt 126 is threaded to fit on female threading formed on top end of cylinder 122. The threading capability provides the means for chain 118 tension adjustment. Chain 118 pulls on arms 86 when rotating CPRS are in the active mode and power is generated on that specific module. The other arms on the shaft in connection with second and third module (not shown) will return the chain to its normal position to complete a full cycle of rotation.

A sprocket 120 is a chain guide mounted at the center end of base 48 at the point where chain 118 changes direction to reach rod 82. If a cable or wire replaces the chain, a pulley or suitable device is installed to replace sprocket. The need for sprocket 120 is diminished when shaft 84 operates directly under the module. Then, rollers (not shown), will be used to keep chain in place while following the movement of arm 86. The need to install rollers or means to reduce friction is essential to keep chain constantly directional to arms 86 while rotational activity is in effect. A pre-determined number of rollers encased in a suitable mount (not shown) will confine chain to a specific point/direction.

The chain is built rugged enough to avoid the consequences of possible stretching due to the constant pressure while pulling on arm 86 and shaft 84. The chain configuration module adds versatility when considering a multi-modular arrangement for full operation. A combination of the first embodiment (FIG. 3) and the second embodiment (FIG. 4) is possible when setting up a configuration similar to arrangement shown in FIG. 5.

The horsepower multiplier module described above can be made functional to operate in different locations of a given power train, e.g., before or after transmission or any combination thereof.

### Conclusion, Ramifications, and Scope

Thus the reader will see that the horsepower multiplier brings a positive adjustment to the unreliability inherent to contemporary methods in use to produce energy for machinery operation. The rotational energy from any horsepower producing apparatus dependent upon existing technologies can be adapted to the horsepower multiplier module. A more reliable multiple of original force is created and applied to machinery for optimum efficiency. While my above description contains much specificity, these should not be construed as limitations on the scope, but rather as an exemplification of several preferred embodiments thereof. Many other variations are possible. For example the base supporting a given rank of cams and the base holding rollers can adopt a triangular or different geometrical shape. The rotating assemblies can be activated by magnetic means similar to the operation of a basic electric motor. The durable material needed where a higher demand for horsepower exists can be substituted for more economical material when powering machines like lawn mowers, power generators, tools, wheeled vehicles, toys and similar devices with less horsepower dependency. Carrier assemblies can provide support for respective components in various ways to include substituting the guide channels for any extension attached or protruding from support frame or a mounting shaft. Two or more modules of a preferred embodiment can be connected to another configuration of modules. Sufficient horsepower is realized to supply wheeled vehicles enough energy to maintain full functionality while on public roads and/or rough terrain. Magnetizing the cells in a timely manner can create the expansion process. Accordingly, the scope should not be determined by the embodiments illustrated, but by the appended claims and their legal equivalents.

I claim:

1. A horsepower multiplier mechanical module, comprising:
a—a plurality of selected cells/rings having a number of cams,
b—an inside carrier rotating assembly having an input gear and channels or means for supporting said selected cells/rings,
c—a plurality of second cells/rings having provisions for insertion of rollers
d—an outside carrier rotating assembly having an input gear and channels or means for supporting said second cells/rings,
e—and a collector or means for transferring the directional force generated after rotational energy is applied to said assemblies, urging said selected cells/rings to expand, whereby the said generated directional force is a multiple of said applied rotational energy and is applied to shaft for distribution to intended application of choice.

2. The horsepower multiplier mechanical module of claim 1 wherein mounting arms/brackets are permanently affixed to inside perimeter of said selected cells/rings.

3. The horsepower multiplier mechanical module of claim 1 wherein mounting arms/brackets or means for support are permanently affixed to outside perimeter of said second selected cells/rings.

4. The horsepower multiplier mechanical module of claim 1 wherein means for friction control or bearings are installed on both sides of said mounting arms/brackets.

5. The horsepower multiplier mechanical module of claim 1 wherein said inside carrier assembly having an input gear provides channels or means for the mounting of said cells/rings.

6. The horsepower multiplier mechanical module of claim 1 wherein said outside carrier assembly having an input gear provides channels or means for the mounting of said second cells/rings.

7. The horsepower multiplier mechanical module of claim 1 wherein rotational energy is applied to said assemblies input gears, urging said cells/rings mounted on channels to rotate and expand, whereby a more effective and reliable directional force is generated as a multiple of initially invested force and is applied to shaft for distribution to application of choice.
